(19) United States
(12) Patent Application Publication
(10) Pub. No.: US 2009/0111438 A1
(43) Pub. Date: Apr. 30, 2009

(54) Streamlined method and system for broadcasting spontaneous invitations to social events

(76) Inventor: Weng Chong Chan, Tigard, OR (US)

Correspondence Address: SHARP LABORATORIES OF AMERICA, INC., 1320 PEARL ST., SUITE 228, BOULDER, CO, 80302, US

(21) Appl. No.: 11/981,046

(22) Filed: Oct. 31, 2007

(51) Int. Cl. H04Q 7/22; H04Q 5/22; H04Q 7/20

(52) U.S. Cl. 455/414.2; 340/10.5; 455/466

(57) ABSTRACT

A method and system streamlines the process of broadcasting spontaneous social invitations to predefined social contacts and improves the prospects of that these social contacts will accept the invitations through judicious integration of contactless identification (ID) technology with a proxy server that sends social invitations on behalf of subscribers using preconfigured subscriber and venue profiles.

### BACKGROUND OF THE INVENTION

The present invention relates to social networking and, more particularly, to a method and system that streamlines broadcasting of spontaneous invitations to social events and improves the prospects of acceptance of these invitations.

Services that enable mobile electronic device users to broadcast spontaneous invitations to social engagements to predefined groups of social contacts are known. One example of such services is Dodgeball.com. In that service, a subscriber can manually text his or her venue (e.g. “@ Local Bar”) to a number hosted by the service. The service then generates and broadcasts an invitation from the subscriber advertising the venue to a predefined group of friends associated with the number. The service may also broadcast the invitation to other subscribers in the same geographic area who the subscriber may or may not know. Other examples of such services leverage location based services (LBS) technology to reduce or eliminate requirements imposed on the subscriber to manually input a venue. In these LBS-based services, the subscriber's approximate position is calculated using Global Positioning System (GPS) or base station triangulation and resolved to a venue. The venue is then automatically advertised to a predefined group of friends.

The services described above have several shortcomings. One shortcoming of the Dodgeball.com service is that it requires the subscriber to manually input his or her venue. This is time consuming and in certain cases the subscriber may not know the name of his or her venue. One shortcoming of the LBS-based services is that in dense urban areas LBS technology is sometimes not accurate enough to resolve the subscriber's position to the correct venue (for example, where the subscriber enters a bar with a restaurant right next door). Moreover, a limitation common to the Dodgeball.com service and LBS-based services is that they fail to advise the subscriber's friends about events and promotions taking place at the venue. Without this additional information, the friends may not have sufficient incentive to join the subscriber at the venue or continue participating in the service.

### SUMMARY OF THE INVENTION

The present invention, in a basic feature, provides a method and system that streamlines the process of broadcasting spontaneous social invitations to predefined social contacts and improves the prospects of that these social contacts will accept the invitations. These dual goals are achieved in some embodiments through judicious integration of contactless identification (ID) technology with a proxy server that sends social invitations on behalf of subscribers using preconfigured subscriber and venue profiles.

In one aspect, a social networking system comprises a contactless ID reader and a proxy server, wherein the contactless ID reader reads at a venue from a mobile electronic device operated by an inviting subscriber inviting subscriber information and transmits from the venue to the proxy server the inviting subscriber information and venue information whereupon the proxy server uses the inviting subscriber information and the venue information to generate an invitation identifying the inviting subscriber, the venue and a scheduled event at the venue.

In some embodiments, the invitation further identifies a scheduled promotion at the venue.

In some embodiments, the proxy server further uses the inviting subscriber information to determine invited subscriber information for social contacts of the inviting subscriber.

In some embodiments, the invited subscriber information is used to deliver the invitation to mobile electronic devices operated by the social contacts.

In some embodiments, the contactless ID reader is a Radio Frequency Identification (RFID) reader and the inviting subscriber information is an identifier from an RFID tag appended to the mobile electronic device operated by the inviting subscriber.

In some embodiments, the invitation is a text message.

In some embodiments, the invitation is a Short Message Service (SMS) message.

In some embodiments, the mobile electronic device operated by the inviting subscriber is a cellular phone.

In some embodiments, the mobile electronic device operated by the inviting subscriber is a personal data assistant (PDA).

In some embodiments, the mobile electronic device operated by the inviting subscriber has a user interface whereon the inviting subscriber inputs a schedule of times when the inviting subscriber information is readable by contactless ID readers.

In another aspect, a social networking system comprises a contactless ID reader and a proxy server, wherein the contactless ID reader reads at a venue from a mobile electronic device inviting subscriber information and transmits from the venue to the proxy server the inviting subscriber information and venue information whereupon the proxy server uses the venue information to determine a plurality of text options for describing in an invitation a scheduled item at the venue.

In some embodiments, the scheduled item comprises a scheduled event.

In some embodiments, the scheduled item comprises a scheduled promotion.

In some embodiments, the plurality of text options is delivered to the venue and the inviting subscriber selects from among the plurality of text options a text option for application to a text message invitation for delivery to mobile electronic devices operated by social contacts of the inviting subscriber.

In another aspect, a social networking method comprises the steps of receiving a contactless ID read from a mobile electronic device operated by an inviting subscriber at a venue and venue information, identifying using the contactless ID an inviting subscriber, identifying using the contactless ID invited subscriber information for social contacts of the inviting subscriber, identifying using the venue information the venue, identifying using the venue information a scheduled event at the venue, generating an invitation identifying the inviting subscriber, the venue and the scheduled event and transmitting using the invited subscriber information the invitation for delivery to mobile electronic devices operated by the social contacts.

In some embodiments, the method further comprises the step of identifying using the venue information a scheduled promotion at the venue, and the generating step further comprises generating an invitation identifying the scheduled promotion.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a social networking system in which the present invention is operative in some embodiments of the invention.

FIG. 2 shows hardware components of a mobile electronic device within the social networking system of FIG. 1 in more detail.

FIG. 3 shows software components of a mobile electronic device within the social networking system of FIG. 1 in more detail.

FIG. 4 shows a social networking method in some embodiments of the invention.

FIG. 5 shows a social networking method in other embodiments of the invention.

### DETAILED DESCRIPTION OF A PREFERRED EMBODIMENT

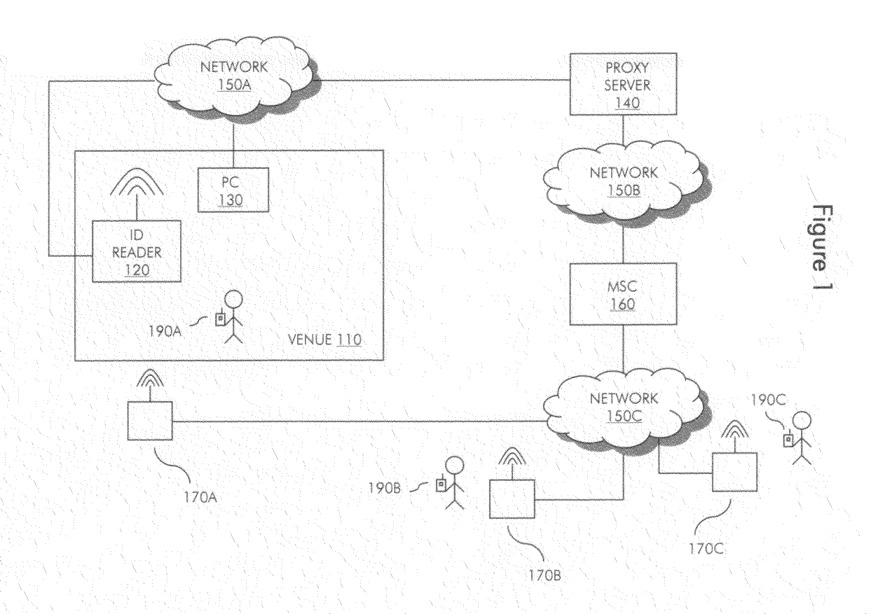

FIG. 1 shows a social networking system in which the present invention is operative in some embodiments. The system includes an ID reader 120 installed within a venue 110. The ID reader 120 is coupled via a communication network 150A to a proxy server 140 remote from venue 110. Proxy server 140 is in turn coupled via a communication network 150B to a message service center (MSC) 160 which is in turn coupled via a communication network 150C to network access points 170A, 170B, 170C. Also within venue 110 are a mobile electronic device 190A operated by a subscriber of the social networking system and a personal computer (PC) 130 operated by venue personnel. Mobile electronic device 190A is within range of ID reader 120 and network access point 170A. Remote from venue 110 are mobile electronic devices 190B, 190C operated by other subscribers of the social networking system who are social contacts of the subscriber who operates mobile electronic device 190A. These remote mobile electronic devices 190B, 190C are within range of network access points 170B, 170C, respectively.

Venue 110 is a social gathering place, such as a restaurant, bar, nightclub, coffee house, bookstore, theater, arcade, park, stadium, arena or amusement park, that sponsors scheduled events and promotions.

ID reader 120 is a contactless ID reader, such as a Radio Frequency Identification (RFID) reader or infrared reader. ID reader 120 may support various contactless ID communication protocols, such as RFID, Near Field Communication (NFC), wireless LAN (Wi-Fi), Bluetooth and/or proprietary protocols, to establish wireless links and transmit and receive data to and from mobile electronic devices. In some embodiments, ID reader 120 reads one or more of active, passive or semi-passive RFID tags appended to mobile electronic devices that are operated by subscribers of the social networking system as the subscribers arrive at venue 110.

Personal computer 130 is a desktop or notebook computer having a user interface for accepting inputs and transmitting outputs to venue personnel, a network interface for transmitting and receiving data to and from communication network 150A and a memory for storing data, all of which are communicatively coupled with a processor for executing in software tasks supported by personal computer 130. Data input by venue personnel on the user interface and transmitted via the network interface include data relating to events and promotions scheduled to take place at venue 110.

Proxy server 140 is a server computer having a user interface for accepting inputs and transmitting outputs to social network system management personnel, a network interface for transmitting and receiving data to and from communication networks 150A, 150B and a database for storing profiles, all of which are communicatively coupled with a processor adapted to execute in software tasks supported by proxy server 140. Profiles stored in the database include subscriber profiles and venue profiles.

A subscriber profile includes, for a subscriber of the social networking system, a subscriber name, contactless ID, contact information, a social contact list (e.g. a “buddy” list) and subscriber preferences. The subscriber name is username of the subscriber, such as the subscriber's first and last name or first name and last initial. The contactless ID is an alphabetic, numeric or alphanumeric identifier that is uniquely associated with the subscriber and can be detected to learn of the subscriber's presence at a venue without disturbing the subscriber. In some embodiments, the contactless ID is a number readable from an RFID tag appended to a mobile electronic device operated by the subscriber. The contact information is an alphabetic, numeric or alphanumeric communication address that is uniquely associated with the subscriber and can be used to contact the subscriber. In some embodiments, the contact information is a cellular phone number, an email address or an Internet Protocol (IP) address. The social contact list includes contactless IDs and/or contact information that is uniquely associated with subscribers who are social contacts of the subscriber. Subscriber preferences are preferences expressed by the subscriber when creating or editing his or her subscriber profile, such as whether the subscriber wishes the system to send invitations to subscribers who are not within the subscriber's social contact list but who, for example, are near the subscriber's location and/or have shared social interests with the subscriber (e.g. shared tastes in music).

A venue profile includes, for a venue of the social networking system, a venue name, a venue ID, contact information, event schedule and promotion schedule. The venue name is a common name of the venue. The venue ID is an alphabetic, numeric or alphanumeric identifier that is uniquely associated with the venue. In some embodiments, the venue ID is configured on an RFID reader installed within the venue. The contact information is an alphabetic, numeric or alphanumeric communication address that is uniquely associated with an ID reader installed within the venue. In some embodiments, the contact information is an IP address. The event schedule is a list of upcoming events at the venue, such as concerts, happy hours, trivia nights, and associated dates and times. The promotion schedule is a list of upcoming promotions at the venue, such as half-price admissions or two-for-one pricing for entrees or drinks, and associated dates and times. In some embodiments, a venue profile also includes multiple text options for an event and/or promotion that subscribers may select among when sending invitations describing the event and/or promotion, such as “Meet me at Bar 10 for happy hour! Two-for-one drinks!” and “Let's get together at Bar 10's happy hour for dinner and drinks.”

Communication networks 150A, 150B, 150C are data communication networks, such as IP-based Local Area Networks (LAN) and Wide Area Networks (WANs), Global System for Mobile Communications (GSM) networks, Universal Mobile Telecommunications System (UMTS) networks, Code Division Multiple Access (CDMA) networks, Worldwide Interoperability for Microwave Access (WiMax) networks, ad-hoc networks and/or other networks. Communication networks 150A, 150B, 150C may include multiplexing nodes, such as routers, switches, bridges or hubs, that operate to communicatively couple communication nodes, such as ID reader 120, personal computer 130, proxy server 140, message service center 160 and network access points 170A, 170B, 170C. In some embodiments, communication networks 150A, 150B include one or more IP-based networks whereas communication network 150C includes one or more GSM, UMTS and/or CDMA networks.

Message service center 160 is a server computer that temporarily stores and delivers invitations and invitation responses to subscribers of the social networking system. In some embodiments, message service center 160 is a Short Message Service Center (SMSC) for temporarily storing and delivering Short Message Service (SMS) text messages in a GSM network.

Network access points 170A, 170B, 170C are wireless communication gateways, such as cellular base stations or wireless LAN access points, that provide access to the social networking system to subscribers who operate mobile electronic devices 190A, 190B, 190C in range of network access points 170A, 170B, 170C.

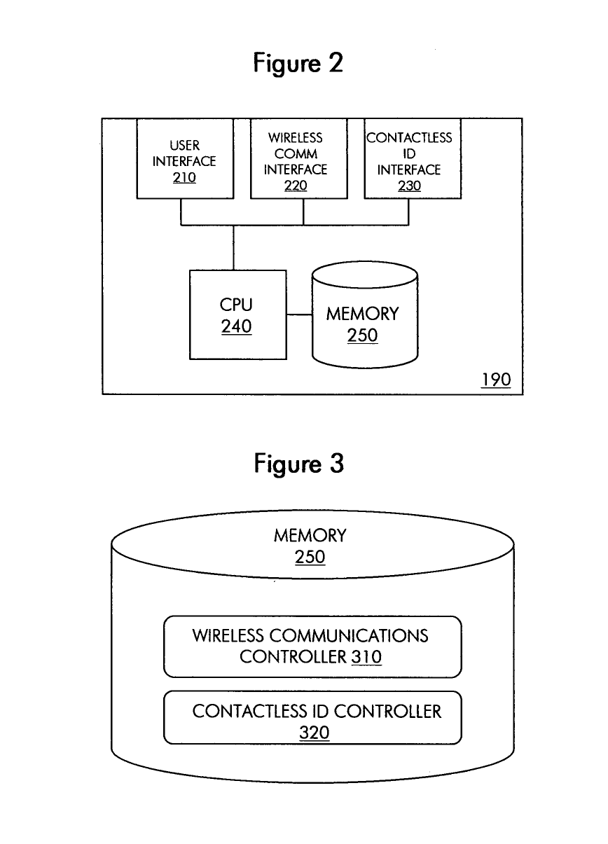

Mobile electronic devices 190A, 190B, 190C are handheld communication devices, such as cellular phones, IP phones or personal data assistants (PDA) that have wireless text messaging capabilities. FIG. 2 shows hardware components of a representative mobile electronic device 190 within the social networking system of FIG. 1 to include a user interface 210, a wireless communication interface 220, a contactless ID interface 230, a processor (CPU) 240 and a memory 250. User interface 210 receives inputs and displays outputs to and from a subscriber who operates device 190. User interface 210 may include, for example, a keypad for inputting text messages and a liquid crystal display (LCD) screen or light emitting diode (LED) display screen for displaying text messages. Wireless communication interface 220 receives and transmits data, such at text messages, over communication networks. Wireless communication interface 220 may be, for example, a cellular network interface or a wireless LAN interface. Contactless ID interface 230 communicates subscriber presence information. In some embodiments, contactless ID interface 230 comprises an RFID transponder having an RFID tag with a contactless ID number uniquely assigned to a subscriber that can be read by RFID readers installed within venues to detect the subscriber's presence. Processor 240 executes in software tasks supported by device 190. Memory 250 stores software executable by processor 240 as well as subscriber data (e.g. subscriber contact lists) and settings. Memory 250 includes one or more random access memories (RAM) and one or more read only memories (ROM).

FIG. 3 shows software components of mobile electronic device 190 executable by processor 240 to include a wireless communication controller 310 and a contactless ID controller 320. Wireless communication controller 310 interoperates with wireless communication interface 220 to provide wireless communication protocol functions, such as wireless link establishment and tear-down and packet formatting, in support of transmission and receipt of voice and data traffic to and from network access points. Protocols supported by wireless communication controller 310 may include, for example, Wi-Fi, IP, GSM, UMTS and/or CDMA protocols. Contactless ID controller 320 interoperates with contactless ID interface 230 to provide contactless ID protocol functions, such as wireless link establishment and tear-down and packet formatting, in support of short-range transmission and receipt of contactless ID information to and from contactless ID readers, such as in-range ID reader 120. Protocols supported by contactless ID controller 320 may include, for example, RFID, NFC, Wi-Fi and/or Bluetooth protocols.

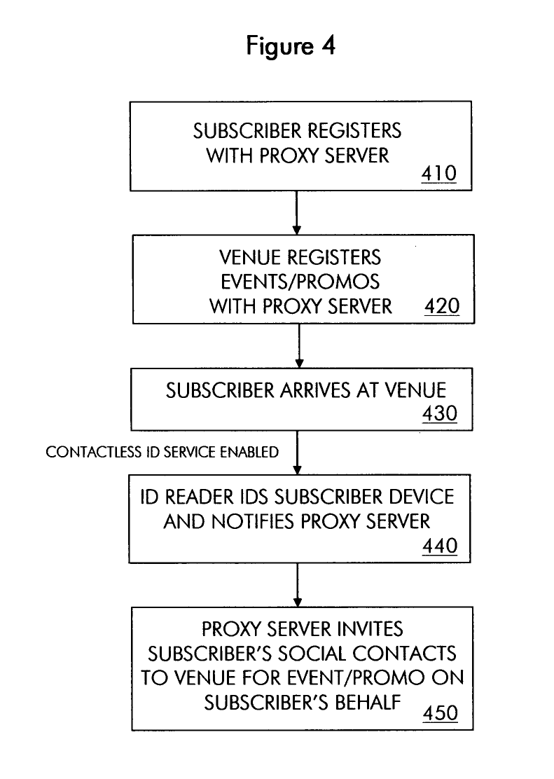

FIG. 4 describes a social networking method in some embodiments of the invention. Initially, the subscriber who operates mobile electronic device 190A registers with proxy server 140 (410). The registration includes a subscriber name, contact information and a social contact list. The subscriber may also register his or her preferences, such as whether the subscriber wishes the system to send invitations to subscribers who are not within the subscriber's social contact list but who are near the subscriber's location and/or have common social interests, for example. Registration may be performed through subscriber input on a web browser of a personal computer or on mobile electronic device 190A. In some embodiments, the contact list stored on mobile electronic device 190A may be transmitted and registered with proxy server 140 as the social contact list. The registered information is stored in a subscriber profile maintained on proxy server 140.

Additionally, venue personnel register with proxy server 140 events and promotions scheduled to take place at venue 110 (420). Registration may be performed through input by venue personnel on personal computer 130 of events and promotions and associated dates and times. The registered information is stored in the venue profile maintained on proxy server 140 for venue 110.

If the contactless ID service is active on mobile electronic device 190A when the subscriber arrives at venue 110 in possession of mobile electronic device 190A (430), ID reader 120 reads from mobile electronic device 190A the contactless ID uniquely associated with the subscriber and transmits the contactless ID and the venue ID configured on ID reader 120 to proxy server 140 via communication network 150A (440).

Proxy server 140 then on behalf of the subscriber invites the social contacts of the subscriber to one or more scheduled events and/or promotions at the venue 110 (450). More particularly, proxy server 140 uses the contactless ID to lookup the subscriber profile and identify from the subscriber profile contact information for the social contacts of the subscriber and uses the venue ID to identify from the venue profile scheduled events and promotions at venue 110. Proxy server 140 then generates a text message invitation announcing arrival of the subscriber at venue 110 and of the scheduled events and/or promotions. For example, where the subscriber has the subscriber name John Doe, venue 110 has the venue name Bar 10, the scheduled event is a concert by the band Pink Martini and the scheduled promotion is half-price admission, proxy server 140 may generate the following text message invitation: “Hi, I'm @ Bar 10. Pink Martini is rocking tonight! Half-price admission!—John Doe” Proxy server 140 then transmits the text message invitation to message service center 160 via communication network 150C for delivery and presentation on mobile electronic devices 190B, 190C. Proxy server 140 may also invite others who are not on the subscriber's social contact list depending on subscriber preferences stored in the subscriber profile.

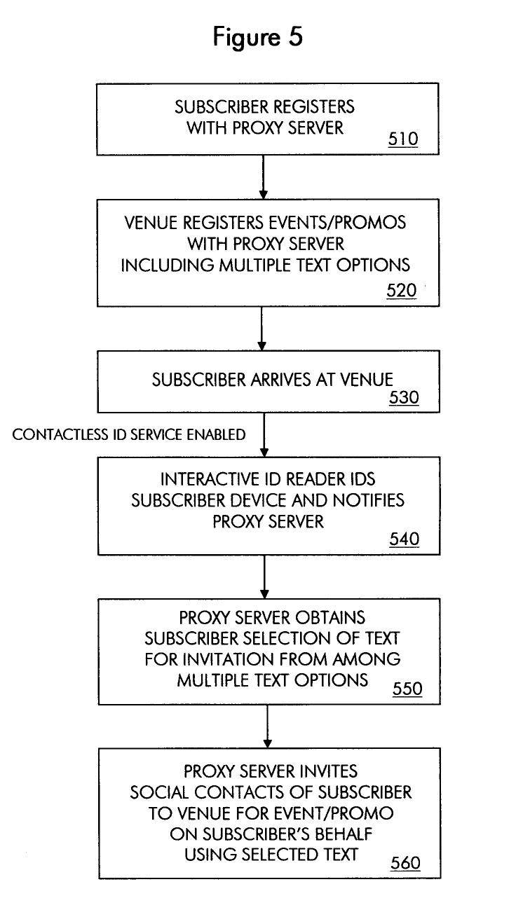

FIG. 5 shows a social networking method in other embodiments of the invention. In these embodiments, the subscriber is allowed to choose text for the invitation from among multiple text options. A subscriber who operates mobile electronic device 190A initially registers with proxy server 140 (510). Additionally, venue personnel register with proxy server 140 events and promotions scheduled to take place at venue 110 (520). In this method, however, venue personnel also register multiple text options for one or more events and/or promotions that subscribers may select among when sending invitations.

If the contactless ID service is active on mobile electronic device 190A when the subscriber arrives at venue 110 in possession of mobile electronic device 190A (530), ID reader 120 reads the contactless ID from mobile electronic device 190A and transmits the contactless ID and the venue ID configured on ID reader 120 to proxy server 140 via communication network 150A (540).

In this method, however, prior to generating a text message invitation, proxy server 140 obtains a subscriber selection of text for the invitation from among multiple text options (550). More particularly, proxy server 140 uses the venue ID to identify from the venue profile multiple text options for one or more scheduled events and promotions at venue 110. Proxy server 140 then presents the multiple text options to the subscriber. In some embodiments, ID reader 120 is an interactive ID reader and the multiple text options are presented and selected on a user interface of ID reader 120. In other embodiments, proxy server 140 generates and transmits to message service center 160 via communication network 150C for delivery and presentation on mobile electronic device 190A a text message presenting the multiple text options and requesting a selection by way of a reply text message. In any event, proxy server 140 receives the subscriber's selection of text for the invitation from among the multiple text options presented to the subscriber.

Proxy server 140 then on behalf of the subscriber invites the social contacts of the subscriber to one or more scheduled events and/or promotions at the venue 110 using the subscriber selected text (560). More particularly, proxy server 140 generates a text message invitation announcing arrival of the subscriber at venue 110 and of the current events and/or promotions using the subscriber selected text. Proxy server 140 then transmits the text message invitation to message service center 160 via communication network 150C for delivery and presentation on mobile electronic devices 190B, 190C. Proxy server 140 may also notify others who are not on the subscriber's social contact list depending on the subscriber's expressed preferences.

Subscribers who receive text message invitations may respond with reply text messages indicating that they accept, decline or request further information. For example, subscribers who operate mobile electronic devices 190B, 190C may generate and transmit reply text messages that are received via network access point 170A by the subscriber who operates mobile electronic device 190A.

The subscriber who operates mobile electronic device 190A may control the availability of his or her contactless ID and his or her availability to receive invitations from other subscribers. In some embodiments, mobile electronic device 190A supports a persistence mode and a synchronization mode. While in persistence mode, the contactless ID on mobile electronic device 190A is readable at all times and mobile electronic device 190A is available to receive invitations at all times. While in synchronization mode, the contactless ID on mobile electronic device 190A is readable and mobile electronic device 190A is available to receive invitations only at scheduled times selected by the subscriber (e.g. when the subscriber is not at work or sleeping). In some embodiments, the subscriber may activate and deactivate the service and select among modes through inputs on user interface 210. In other embodiments, such as where contactless ID interface 230 comprises a passive RFID tag (i.e. a tag powered by the incoming RF signal), the subscriber may be required to contact proxy server 140 in order to activate and deactivate the service. For example, a subscriber may in some embodiments notify proxy server 140 of a schedule of times when proxy server 140 is enabled to generate invitations using an always-readable contactless ID read from a mobile electronic device operated by the subscriber.

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A social networking system, comprising:
a contactless identification (ID) reader; and
a proxy server, wherein the contactless ID reader reads at a venue from a mobile electronic device operated by an inviting subscriber inviting subscriber information and transmits from the venue to the proxy server the inviting subscriber information and venue information whereupon the proxy server uses the inviting subscriber information and the venue information to generate and transmit an invitation identifying the inviting subscriber, the venue and a scheduled event at the venue.

2. The system of claim 1, wherein the invitation further identifies a scheduled promotion at the venue.

3. The system of claim 1, wherein the proxy server further uses the inviting subscriber information to determine invited subscriber information for social contacts of the inviting subscriber.

4. The system of claim 3, wherein the invited subscriber information is used to deliver the invitation to mobile electronic devices operated by the social contacts.

5. The system of claim 1, wherein the contactless ID reader is a Radio Frequency Identification (RFID) reader and the inviting subscriber information is an identifier from an RFID tag appended to the mobile electronic device operated by the inviting subscriber.

6. The system of claim 1, wherein the invitation is a text message.

7. The system of claim 6, wherein the invitation is a Short Message Service (SMS) message.

8. The system of claim 1, wherein the mobile electronic device operated by the inviting subscriber is a cellular phone.

9. The system of claim 1, wherein the mobile electronic device operated by the inviting subscriber is a personal data assistant (PDA).

10. The system of claim 1, wherein the mobile electronic device operated by the inviting subscriber has a user interface whereon the inviting subscriber inputs a schedule of times when the inviting subscriber information is readable by contactless ID readers.

11. The system of claim 1, wherein the inviting subscriber notifies the proxy server of a schedule of times when the proxy server is enabled to generate invitations using inviting subscriber information read from the mobile electronic device by contactless ID readers.

12. A social networking system, comprising:
a contactless ID reader; and
a proxy server, wherein the contactless ID reader reads at a venue from a mobile electronic device operated by an inviting subscriber inviting subscriber information and transmits from the venue to the proxy server the inviting subscriber information and venue information whereupon the proxy server uses the venue information to determine a plurality of text options for describing in an invitation a scheduled item at the venue.

13. The system of claim 12, wherein the scheduled item comprises a scheduled event.

14. The system of claim 12, wherein the scheduled item comprises a scheduled promotion.

15. The system of claim 12, wherein plurality of text options is delivered to the venue and the inviting subscriber selects from among the plurality of text options a text option for application to a text message invitation for delivery to mobile electronic devices operated by social contacts of the inviting subscriber.

16. A social networking method, comprising the steps of:
receiving a contactless ID read from a mobile electronic device operated by an inviting subscriber at a venue and venue information;
identifying using the contactless ID an inviting subscriber;
identifying using the contactless ID invited subscriber information for social contacts of the inviting subscriber;
identifying using the venue information the venue;
identifying using the venue information a scheduled event at the venue;
generating an invitation identifying the inviting subscriber, the venue and the scheduled event; and
transmitting using the invited subscriber information the invitation for delivery to mobile electronic devices operated by the social contacts.

17. The method of claim 16, further comprising the step of identifying using the venue information a scheduled promotion at the venue, wherein the generating step further comprises generating an invitation identifying the scheduled promotion.
